(19) United States
(12) Patent Application Publication
(10) Pub. No.: US 2018/0095630 A1
(43) Pub. Date: Apr. 5, 2018

(54) SYSTEMS, DEVICES, AND METHODS FOR MITIGATING FALSE POSITIVES IN HUMAN-ELECTRONICS INTERFACES

(71) Applicant: THALMIC LABS INC., Kitchener (CA)

(72) Inventor: Matthew Bailey, Kitchener (CA)

(21) Appl. No.: 15/819,869

(22) Filed: Nov. 21, 2017

Related U.S. Application Data
(63) Continuation of application No. 15/072,918, filed on Mar. 17, 2016.
(60) Provisional application No. 62/136,207, filed on Mar. 20, 2015.

(51) Int. Cl. G06F 3/0487; G06F 3/01; G06F 1/16

(52) U.S. Cl. CPC G06F 3/0487; G06F 3/015; G06F 3/011; G06F 3/017; G06F 1/163; G06F 3/013

(57) ABSTRACT

Systems, devices, and methods for mitigating false-positives in human-electronics interfaces are described. A human-electronics interface includes a first interface device that is responsive to inputs of a first form from a user and a second interface device that is responsive to inputs of a second form from the user. The first interface device enables the user to control the interface through inputs of the first form while the second interface device enables the user to control, through inputs of the second form, at least a locked/unlocked state of the interface with respect to the first interface device. In the locked state, the interface is unresponsive to inputs (in particular, accidental inputs or “false-positives”) of the first form whereas in the unlocked state the interface is responsive to inputs of the first form.

### BACKGROUND

### Technical Field

The present systems, devices, and methods generally relate to human-electronics interfaces and particularly relate to mitigating false positives in human-electronics interfaces.

### Description of the Related Art

### Wearable Electronic Devices

Electronic devices are commonplace throughout most of the world today. Advancements in integrated circuit technology have enabled the development of electronic devices that are sufficiently small and lightweight to be carried by the user. Such “portable” electronic devices may include on-board power supplies (such as batteries or other power storage systems) and may be designed to operate without any wire-connections to other, non-portable electronic systems; however, a small and lightweight electronic device may still be considered portable even if it includes a wire-connection to a non-portable electronic system. For example, a microphone may be considered a portable electronic device whether it is operated wirelessly or through a wire-connection.

The convenience afforded by the portability of electronic devices has fostered a huge industry. Smartphones, audio players, laptop computers, tablet computers, and ebook readers are all examples of portable electronic devices. However, the convenience of being able to carry a portable electronic device has also introduced the inconvenience of having one's hand(s) encumbered by the device itself. This problem is addressed by making an electronic device not only portable, but wearable.

A wearable electronic device is any portable electronic device that a user can carry without physically grasping, clutching, or otherwise holding onto the device with their hands. For example, a wearable electronic device may be attached or coupled to the user by a strap or straps, a band or bands, a clip or clips, an adhesive, a pin and clasp, an article of clothing, tension or elastic support, an interference fit, an ergonomic form, etc. Examples of wearable electronic devices include digital wristwatches, electronic armbands, electronic rings, electronic ankle-bracelets or “anklets,” head-mounted electronic display units, hearing aids, and so on.

### Wearable Heads-Up Displays

While wearable electronic devices may be carried and, at least to some extent, operated by a user without encumbering the user's hands, many wearable electronic devices include at least one electronic display. Typically, in order for the user to access (i.e., see) and interact with content presented on such electronic displays, the user must modify their posture to position the electronic display in their field of view (e.g., in the case of a wristwatch, the user may twist their arm and raise their wrist towards their head) and direct their attention away from their external environment towards the electronic display (e.g., look down at the wrist bearing the wristwatch). Thus, even though the wearable nature of a wearable electronic device allows the user to carry and, to at least some extent, operate the device without occupying their hands, accessing and/or interacting with content presented on an electronic display of a wearable electronic device may occupy the user's visual attention and limit their ability to perform other tasks at the same time.

The limitation of wearable electronic devices having electronic displays described above may be overcome by wearable heads-up displays. A wearable heads-up display is a head-mounted display that enables the user to see displayed content but does not prevent the user from being able to see their external environment. A typical head-mounted display (e.g., well-suited for virtual reality applications) may be opaque and prevent the user from seeing their external environment, whereas a wearable heads-up display (e.g., well-suited for augmented reality applications) may enable a user to see both real and virtual/projected content at the same time. A wearable heads-up display is an electronic device that is worn on a user's head and, when so worn, secures at least one display within a viewable field of at least one of the user's eyes at all times, regardless of the position or orientation of the user's head, but this at least one display is either transparent or at a periphery of the user's field of view so that the user is still able to see their external environment. Examples of wearable heads-up displays include: the Google Glass®, the Optinvent Ora®, the Epson Moverio®, the Sony Glasstron®, just to name a few.

### Human-Electronics Interfaces and Devices

A human-electronics interface mediates communication between a human and one or more electronic device(s). In general, a human-electronics interface is enabled by one or more electronic interface device(s) that a) detect inputs effected by the human and convert those inputs into signals that can be processed or acted upon by the one or more electronic device(s), and/or b) respond or otherwise provide outputs to the human from the one or more electronic device(s), where the user is able to understand some information represented by the outputs. A human-electronics interface may be one directional or bidirectional, and a complete interface may make use of multiple interface devices. For example, the computer mouse is a one-way interface device that detects inputs effected by a user of a computer and converts those inputs into signals that can be processed by the computer, while the computer's display or monitor is a one-way (provided it is not a touchscreen) interface device that provides outputs to the user in a form through which the user can understand information. Together, the computer mouse and display complete a bidirectional human-computer interface (“HCI”). A HCI is an example of a human-electronics interface. The present systems, devices, and methods may be applied to HCIs, but may also be applied to any other form of human-electronics interface.

A wearable electronic device may function as an interface device if, for example, the wearable electronic device includes sensors that detect inputs effected by a user and either provides outputs to the user based on those inputs or transmits signals to another electronic device based on those inputs. Sensor-types and input-types may each take on a variety of forms, including but not limited to: tactile sensors (e.g., buttons, switches, touchpads, or keys) providing manual control, acoustic sensors providing voice-control, electromyography sensors providing gestural control, and/or accelerometers providing gestural control.

### Always-on Interfaces

An “always-on” interface is a human-electronics interface in which, when powered ON, at least one electronic interface device operates by continuously or continually (i.e., either at all times or repeatedly at discrete points in time) monitoring, scanning, checking, or otherwise “looking” for inputs from the user. An always-on interface device actively processes incoming data and repeatedly checks for inputs from the user. This is in contrast to a passive interface device, such as a button or a switch, which simply exists in an inactive and unactuated state until effectuation or activation by the user. Examples of always-on interface devices include: a microphone that enables a voice-control interface, an eye-tracker that enables control of displayed content based on the direction of a user's gaze, a Myo™ gesture control armband that enables gestural control of electronic devices, and the like. For each of these examples, the interface device in operation continually senses data (e.g., acoustic data for the microphone, eye-position data for the eye-tracker, and electromyography data for the Myo armband) and analyzes this data to detect and identify when the user is deliberately attempting to effect control of the interface.

“False positives” occur when an interface device incorrectly identifies that the user has effected an input when in actuality the user did not intend to effect any such input. Preventing the occurrence of false positives is an on-going challenge in the implementation of always-on interfaces. As an example, a false positive occurs in a voice-control interface when the system interprets that the user has spoken a specific instruction when in fact the user did not speak the instruction (i.e., the interface “mishears” what the user has said), or the user spoke the instruction but did not intend for the utterance to be interpreted as an instruction (i.e., the interface misconstrues the context in which the user has said something). A common strategy to reduce the occurrence of false positives in an always-on interface device is to implement a lock/unlock scheme. In a typical lock/unlock scheme, the interface device defaults to a “locked” state in which the only instruction that can be effected is an “unlock” instruction. Once the system registers an “unlock” instruction, the system enters an “unlocked” state in which other instructions can be effected. Depending on the implementation, the unlocked state may have a defined duration or last only until another instruction is identified, after which the system may return to the locked state. Continuing with the voice-control example, a specific word or phrase (e.g., “OK Glass” as used in the Google Glass® voice-control interface) may be used to unlock a voice-control interface. Implementing a lock/unlock scheme in an always-on interface device generally works to reduce the number of false positives while the system is in the locked state, essentially because it whittles the number of identifiable instructions down to one while in the locked state. However, conventional lock/unlock schemes typically achieve limited success because they implement a lock/unlock mechanism that employs the same form of input that is used to effect the other instructions. Conventional voice-control interfaces are unlocked by a vocal input, conventional gestural control interfaces are unlocked by a gestural input, and so on. Because the same form of input that controls the interface is also used to unlock the controller, conventional lock/unlock schemes are highly susceptible to accidental unlocking (i.e., false positives of the unlock instruction) and false positives while in the accidental unlocked state. There is a need in the art for improved mechanisms for reducing false positives in human-electronics interfaces.

### BRIEF SUMMARY

A method of controlling a human-electronics interface, wherein the human-electronics interface comprises a first interface device responsive to inputs of a first form from a user and a second interface device responsive to inputs of a second form from the user, the second form different from the first form, may be summarized as including: entering the human-electronics interface into a locked state with respect to the first interface device, wherein in the locked state with respect to the first interface device the human-electronics interface is unresponsive to inputs of the first form from the user; detecting, by the second interface device, an input of the second form from the user; and in response to detecting, by the second interface device, the input of the second form from the user, entering the human-electronics interface into an unlocked state with respect to the first interface device, wherein in the unlocked state with respect to the first interface device the human-electronics interface is responsive to inputs of the first form from the user. Detecting, by the second interface device, an input of the second form from the user may include detecting, by the second interface device, an indication from the user that the user wishes to cause the human-electronics interface to enter into the unlocked state with respect to the first interface device, the indication from the user corresponding to a particular input of the second form. The method may further include, while the human-electronics interface is in the unlocked state with respect to the first interface device: detecting, by the first interface device, an input of the first form from the user; and in response to detecting, by the first interface device, the input of the first form from the user, effecting a control of the human-electronics interface.

The method may further include: reentering the human-electronics interface into the locked state with respect to the first interface device. Reentering the human-electronics interface into the locked state with respect to the first interface device may include reentering the human-electronics interface into the locked state with respect to the first interface device in response to at least one trigger selected from a group consisting of: a particular input of the second form detected by the second interface device, a particular input of the first form detected by the first interface device, a particular combination of at least one input of the first form detected by the first interface device and at least one input of the second form detected by the second interface device, an elapsed time without detecting any inputs of the first form by the first interface device, and an elapsed time without detecting any inputs of the second form by the second interface device.

The second interface device may include an eye-tracker and inputs of the second form may include specific eye-positions and/or gaze directions of the user. Detecting, by the second interface device, an input of the second form from the user may include detecting, by the eye-tracker, a particular eye position and/or gaze direction of the user. The human-electronics interface may include a wearable heads-up display that includes and/or carries the eye-tracker. The particular eye-position and/or gaze direction of the user may correspond to a specific display region of the wearable heads-up display. The first interface device may include a gesture control device and inputs of the first form may include gestures performed by the user. In this case, the method may further include, while the human-electronics interface is in the unlocked state with respect to the first interface device: detecting, by the gesture control device, a gesture performed by the user; and in response to detecting, by the gesture control device, the gesture performed by the user, effecting a control of the human-electronics interface. The method may include, while the human-electronics interface is in the unlocked state with respect to the first interface device: detecting, by the eye-tracker, that the eye position and/or gaze direction of the user has changed from the particular eye position and/or gaze direction; and in response to detecting, by the eye-tracker, that the eye position and/or gaze direction of the user has changed from the particular eye position and/or gaze direction, reentering the human-electronics interface into the locked state with respect to the first interface device.

The first interface device may include a portable interface device having at least one actuator and inputs of the first form may include activations of at least one actuator of the portable interface device by the user. In this case, the method may further include, while the human-electronics interface is in the unlocked state with respect to the first interface device: detecting, by the portable interface device, an activation of at least one actuator by the user; and in response to detecting, by the portable interface device, the activation of at least one actuator by the user, effecting a control of the human-electronics interface.

The second interface device may include a portable interface device having at least one actuator and inputs of the second form may include activations of at least one actuator of the portable interface device by the user. In this case, detecting, by the second interface device, an input of the second form from the user may include detecting, by the portable interface device, a particular activation of at least one actuator by the user. The first interface device may include an eye tracker and inputs of the first form may include specific eye-positions and/or gaze directions of the user. In this case, the method may further include, while the human-electronics interface is in the unlocked state with respect to the first interface device: detecting, by the eye tracker, an eye-position and/or gaze direction of the user; and in response to detecting, by the eye tracker, the eye position and/or gaze direction of the user, effecting a control of the human-electronics interface.

Entering the human-electronics interface into a locked state with respect to the first interface device may include entering the first interface device into a locked state in which the first interface device is unresponsive to inputs of the first form from the user. Entering the human-electronics interface into an unlocked state with respect to the first interface device may include entering the first interface device into an unlocked state in which the first interface device is responsive to inputs of the first form from the user. The first interface device may include a processor and a non-transitory processor-readable storage medium communicatively coupled to the processor, wherein the non-transitory processor-readable storage medium stores processor-executable locking instructions and processor-executable unlocking instructions. In this case, entering the first interface device into a locked state in which the first interface device is unresponsive to inputs of the first form from the user may include executing, by the processor of the first interface device, the processor-executable locking instructions to cause the first interface device to enter into the locked state and entering the first interface device into an unlocked state in which the first interface device is responsive to inputs of the first form from the user may include executing, by the processor of the first interface device, the processor-executable unlocking instructions to cause the first interface device to enter into the unlocked state.

The human-electronics interface may include a controlled device that is communicatively coupled to the first interface device. In this case, entering the human-electronics interface into a locked state with respect to the first interface device may include entering the controlled device into a locked state in which the controlled device is unresponsive to control signals from the first interface device; and entering the human-electronics interface into an unlocked state with respect to the first interface device may include entering the controlled device into an unlocked state in which the controlled device is responsive to control signals from the first interface device. The controlled device may include a processor and a non-transitory processor-readable storage medium communicatively coupled to the processor, wherein the non-transitory processor-readable storage medium stores processor-executable locking instructions and processor-executable unlocking instructions. Entering the controlled device into a locked state in which the controlled device is unresponsive to control signals from the first interface device may include executing, by the processor of the controlled device, the processor-executable locking instructions to cause the controlled device to enter into the locked state; and entering the controlled device into an unlocked state in which the controlled device is responsive to control signals from the first interface device may include executing, by the processor of the controlled device, the processor-executable unlocking instructions to cause the controlled device to enter into the unlocked state.

The second interface device may include a processor and a non-transitory processor-readable storage medium communicatively coupled to the processor, wherein the non-transitory processor-readable storage medium stores processor-executable input detection instructions. Detecting, by the second interface device, an input of the second form from the user may include executing, by the processor of the second interface device, the processor-executable input detection instructions to cause the second interface device to detect an input of the second form from the user.

A human-electronics interface may be summarized as including: a first interface device responsive to inputs of a first form from a user, wherein the first interface device includes a first processor and a first non-transitory processor-readable storage medium communicatively coupled to the first processor, and wherein the first non-transitory processor-readable storage medium stores: processor-executable locking instructions that, when executed by the first processor, cause the human-electronics interface to enter into a locked state with respect to the first interface device, wherein in the locked state with respect to the first interface device the human-electronics interface is unresponsive to inputs of the first form from the user; and processor-executable unlocking instructions that, when executed by the first processor, cause the human-electronics interface to enter into an unlocked state with respect to the first interface device, wherein in the unlocked state with respect to the first interface device the human-electronics interface is responsive to inputs of the first form from the user; and a second interface device responsive to inputs of a second form from the user, the second form different from the first form, wherein the second interface device includes a second processor and a second non-transitory processor-readable storage medium communicatively coupled to the second processor, and wherein the second non-transitory processor-readable storage medium stores processor-executable input processing instructions that, when executed by the second processor, cause the second interface device to: in response to detecting an input of the second form from the user, cause the first processor of the first interface device to execute the processor-executable unlocking instructions. The second interface device may include an eye-tracker and inputs of the second form may include specific eye-positions and/or gaze directions of the user. The human-electronics interface may further include a wearable heads-up display that includes and/or carries the eye-tracker, wherein the specific eye-positions and/or gaze directions of the user correspond to specific display regions of the wearable heads-up display.

The first interface device may include at least one device selected from a group consisting of: a gesture control device for which inputs of the first form my include gestures performed by the user and detected by the gesture control device, and a portable interface device including at least one actuator for which inputs of the first form include activations of at least one actuator by the user.

The human-electronics interface may further include a wearable heads-up display that includes the first interface device, wherein the first interface device includes an eye-tracker and inputs of the first form include specific eye-positions and/or gaze directions of the user that correspond to specific display regions of the wearable heads-up display.

The processor-executable locking instructions that, when executed by the first processor while the human-electronics interface is in the unlocked state with respect to the first interface device, cause the human-electronics interface to enter into a locked state with respect to the first interface device, may cause the human-electronics interface to enter into the locked state with respect to the first interface device in response to at least one trigger selected from a group consisting of: a particular input of the second form detected by the second interface device, a particular input of the first form detected by the first interface device, a particular combination of at least one input of the first form detected by the first interface device and at least one input of the second form detected by the second interface device, an elapsed time without detecting any inputs of the first form by the first interface device, and an elapsed time without detecting any inputs of the second form by the second interface device.

A human-electronics interface may be summarized as including: a first interface device responsive to inputs of a first form from a user, wherein the first interface device includes a first processor and a first non-transitory processor-readable storage medium communicatively coupled to the first processor, and wherein the first non-transitory processor-readable storage medium stores: processor-executable locking instructions that, when executed by the first processor, cause the first interface device to enter into a locked state in which the first interface device is unresponsive to inputs of the first form from the user; and processor-executable unlocking instructions that, when executed by the first processor, cause the first interface device to enter into an unlocked state in which the first interface device is responsive to inputs of the first form from the user; and a second interface device responsive to inputs of a second form from the user, wherein the second interface device includes a second processor and a second non-transitory processor-readable storage medium communicatively coupled to the second processor, and wherein the second non-transitory processor-readable storage medium stores processor-executable input detection instructions that, when executed by the second processor, cause the second interface device to: detect an input of the second form from the user; and in response to detecting the input of the second form from the user, cause the first processor of the first interface device to execute the processor-executable unlocking instructions.

A human-electronics interface may be summarized as including: a first interface device responsive to inputs of a first form from a user, wherein the first interface device includes a first processor and a first non-transitory processor-readable storage medium communicatively coupled to the first processor, and wherein the first non-transitory processor-readable storage medium stores processor-executable input detection instructions that, when executed by the first processor, cause the first interface device to: detect an input of the first form from the user; and in response to detecting the input of the first form from the user, transmit at least one control signal; a controlled device that includes a second processor and a second non-transitory processor-readable storage medium communicatively coupled to the second processor, wherein the second non-transitory processor-readable storage medium stores: processor-executable locking instructions that, when executed by the second processor, cause the controlled device to enter into a locked state in which the controlled device is unresponsive to control signals from the first interface device; and processor-executable unlocking instructions that, when executed by the second processor, cause the controlled device to enter into an unlocked state in which the controlled device is responsive to control signals from the first interface device; and a second interface device responsive to inputs of a second form from the user, wherein the second interface device includes a third processor and a third non-transitory processor-readable storage medium communicatively coupled to the third processor, and wherein the third non-transitory processor-readable storage medium stores processor-executable input detection instructions that, when executed by the third processor, cause the second interface device to: detect an input of the second form from the user; and in response to detecting the input of the second form from the user, cause the second processor of the controlled device to execute the processor-executable unlocking instructions.

A human-electronics interface may be summarized as including: a first interface device responsive to inputs of a first form from a user; a second interface device responsive to inputs of a second form from the user, the second form different from the first form, wherein the second interface device comprises a processor and a non-transitory processor-readable storage medium communicatively coupled to the processor, and wherein the non-transitory processor-readable storage medium stores: processor-executable locking instructions that, when executed by the processor, cause the human-electronics interface to enter into a locked state with respect to the first interface device, wherein in the locked state with respect to the first interface device the human-electronics interface is unresponsive to inputs of the first form from the user; processor-executable unlocking instructions that, when executed by the processor, cause the human-electronics interface to enter into an unlocked state with respect to the first interface device, wherein in the unlocked state with respect to the first interface device the human-electronics interface is responsive to inputs of the first form from the user; and processor-executable input processing instructions that, when executed by the processor, cause the second interface device to, in response to detecting an input of the second form from the user, cause the processor to execute the processor-executable unlocking instructions. The human-electronics interface may further include a wearable heads-up display that includes the second interface device, wherein the second interface device includes an eye-tracker and inputs of the second form include specific eye-positions and/or gaze directions of the user that correspond to specific display regions of the wearable heads-up display. The first interface device may include at least one device selected from a group consisting of: a gesture control device for which inputs of the first form include gestures performed by the user and detected by the gesture control device, and a portable interface device that includes at least one actuator for which inputs of the first form include activations of at least one actuator by the user.

The processor-executable locking instructions that, when executed by the processor while the human-electronics interface is in the unlocked state with respect to the first interface device, cause the human-electronics interface to enter into a locked state with respect to the first interface device, may cause the human-electronics interface to enter into the locked state with respect to the first interface device in response to at least one trigger selected from a group consisting of: a particular input of the second form detected by the second interface device, a particular input of the first form detected by the first interface device, a particular combination of at least one input of the first form detected by the first interface device and at least one input of the second form detected by the second interface device, an elapsed time without detecting any inputs of the first form by the first interface device, and an elapsed time without detecting any inputs of the second form by the second interface device.

A human-electronics interface may be summarized as including: a first interface device responsive to inputs of a first form from a user, wherein in response to detecting an input of the first form from the user the first interface device transmits at least one control signal; a controlled device that includes a first processor and a first non-transitory processor-readable storage medium communicatively coupled to the first processor, wherein the first non-transitory processor-readable storage medium stores: processor-executable locking instructions that, when executed by the first processor, cause the controlled device to enter into a locked state in which the controlled device is unresponsive to control signals from the first interface device; and processor-executable unlocking instructions that, when executed by the first processor, cause the controlled device to enter into an unlocked state in which the controlled device is responsive to control signals from the first interface device; and a second interface device responsive to inputs of a second form from the user, the second form different from the first form, wherein the second interface device includes a second processor and a second non-transitory processor-readable storage medium communicatively coupled to the second processor, and wherein the second non-transitory processor-readable storage medium stores processor-executable input processing instructions that, when executed by the second processor, cause the second interface device to: in response to detecting an input of the second form from the user, cause the first processor of the controlled device to execute the processor-executable unlocking instructions. The controlled device may include a wearable heads-up display that carries the second interface device, and the second interface device may include an eye tracker for which inputs of the second form include specific eye-positions and/or gaze directions of the user that correspond to specific display regions of the wearable heads-up display. The first interface device may include at least one device selected from a group consisting of: a gesture control device for which inputs of the first form include gestures performed by the user and detected by the gesture control device, and a portable interface device that includes at least one actuator for which inputs of the first form include activations of at least one actuator ice by the user. The processor-executable locking instructions that, when executed by the first processor of the controlled device while the controlled device is in the unlocked state with respect to the first interface device, cause the controlled device to enter into a locked state with respect to the first interface device, may cause the controlled device to enter into the locked state with respect to the first interface device in response to at least one trigger selected from a group consisting of: a particular input of the second form detected by the second interface device, a particular input of the first form detected by the first interface device, a particular combination of at least one input of the first form detected by the first interface device and at least one input of the second form detected by the second interface device, an elapsed time without detecting any inputs of the first form by the first interface device, and an elapsed time without detecting any inputs of the second form by the second interface device.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is an illustrative diagram of an exemplary human-electronics interface comprising a first interface device that is responsive to inputs of a first form from a user and a second interface device that is responsive to inputs of a second form from the user in accordance with the present systems, devices, and methods.

FIG. 2 is an illustrative diagram showing a human-electronics interface in which a user wears both a first interface device and a second interface device in accordance with the present systems, devices, and methods.

FIG. 3 is a flow-diagram showing an exemplary method of controlling a human-electronics interface in accordance with the present systems, devices, and methods.

FIG. 4 is an illustrative diagram of another exemplary human-electronics interface comprising a first interface device that is responsive to inputs of a first form from a user and a second interface device that is responsive to inputs of a second form from the user in accordance with the present systems, devices, and methods.

FIG. 5 is an illustrative diagram showing another human-electronics interface in which a user wears both a first interface device and a second interface device in accordance with the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electronic devices, and in particular portable electronic devices such as wearable electronic devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

The various embodiments described herein provide systems, devices, and methods for mitigating false positives in human-electronics interfaces. As previously described, a “false positive” occurs when an interface device incorrectly identifies that the user has effected an input when in actuality the user did not intend to effect any such input. Conventionally, false positives may be mitigated by controllably switching an interface device between two states: an unlocked state in which the interface device is responsive to inputs from the user and a locked state in which the interface device is unresponsive to all inputs from the user except for an unlocking input. In the locked state, the interface device is typically still responsive to a direct unlocking input from the user. Such conventional schemes are of limited effectiveness because even while in a locked state, the interface device is susceptible to false positives of the unlocking input. The present systems, devices, and methods improve upon conventional locking/unlocking schemes by combining a first interface device that is responsive to inputs of a first form from the user and a second interface device that is responsive to inputs of a second form from the user, where the first interface device is used to control, via inputs of the first form, the human-electronics interface and the second interface device is used to control, via inputs of the second form, at least the locked/unlocked state of the interface with respect to the first interface device. As an example, a gesture control device (such as the Myo™ gesture control armband) may be used to interact with content displayed by a wearable heads-up display as described in US Patent Publication US 2014-0198035 A1 (which is incorporated herein by reference in its entirety) while the locked/unlocked state of the interface with respect to the gesture control device (at least, in relation to content displayed by the wearable heads-up display) may be controlled by an eye-tracker carried on-board the wearable heads-up display. In this example, content displayed on the wearable heads-up display may only be responsive to gesture-based inputs from the user (via the gesture control device) when the eye-tracker determines that the user is actually looking at the displayed content.

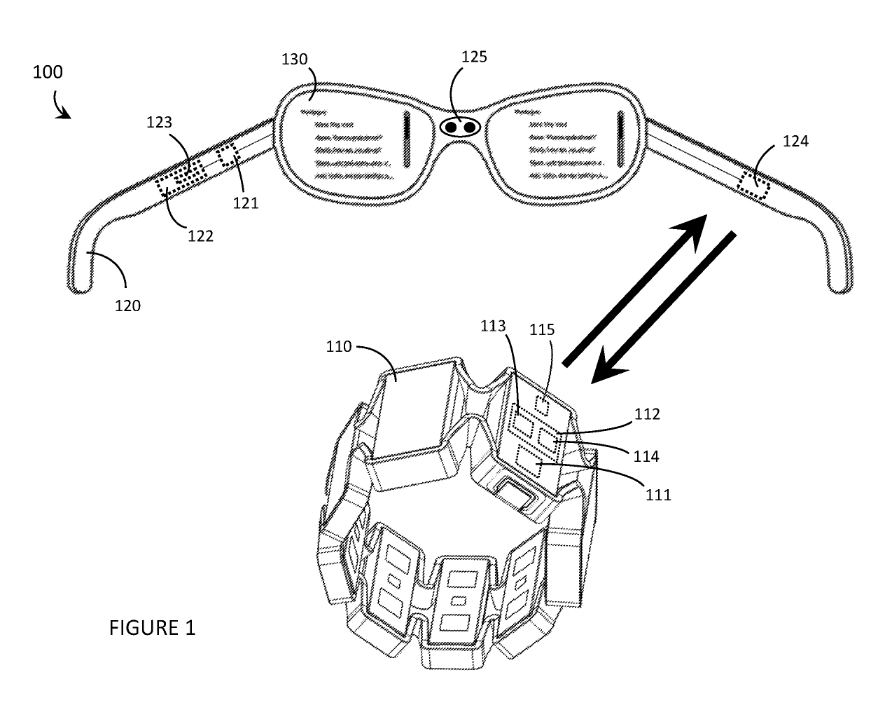

FIG. 1 is an illustrative diagram of an exemplary human-electronics interface 100 comprising a first interface device 110 that is responsive to inputs of a first form from a user and a second interface device 125 that is responsive to inputs of a second form from the user in accordance with the present systems, devices, and methods. In exemplary interface 100, first interface device 110 is a gesture control device (such as a Myo™ armband) that is responsive to physical gestures performed by the user (when device 110 is worn by the user) and second interface device 125 is an eye-tracker (carried by a wearable heads-up display 120) that is responsive to eye positions and/or eye movements of the user 125 (when wearable heads-up display 120 is worn by the user). Eye-tracker 125 may track one or both eyes of the user and may implement any known devices and methods for eye-tracking based on, for example: images/video from cameras, reflection of projected/scanned infrared light, detection of iris or pupil position, detection of glint origin, and so on. Wearable heads-up display 120 provides display content 130 to the user and the user interacts with display content 130 by performing physical gestures that are detected by first interface device 110 as described in US Patent Publication US 2014-0198035 A1. That is, wearable heads-up display 120 is a “controlled device” that is controlled by at least first interface device (gesture control device) 110, and optionally by second interface device (eye tracker) 125 as well. In accordance with the present systems, devices, and methods, second interface device 125 controls (e.g., based on the user's eye position and/or gaze direction) at least the locked/unlocked state of interface 100 with respect to gestural inputs from first interface device 110.

Interface 100 may enter into a locked state with respect to gesture control device 110. While in the locked state with respect to gesture control device 110, interface 100 (e.g., display content 130 of wearable heads-up display 120) may be unresponsive to physical gestures performed by the user which are detected or detectable by the gesture control device 110, yet may be responsive to other user input detected or detectable by other user input devices (e.g., eye-tracker 125, a button, a key or a touch-sensitive switch, for instance carried on a frame of wearable heads-up display 120). Interface 100 may enter into an unlocked state with respect to gesture control device 110 in response to a determination by eye-tracker 125 that the user wishes to interact with display content 130. While in the unlocked state with respect to gesture control device 110, interface 110 (e.g., display content 130) may be responsive to physical gestures performed by the user. Two examples of different operational implementations of this concept are now described.

In a first example (“Example A”), the locked state of interface 100 “with respect to gesture control device 110” may be achieved by “locking” gesture control device 110 itself with respect to detecting, processing, and/or transmitting control signals in response to, physical gestures performed by the user. In other words, entering interface 100 into a “locked state with respect to gesture control device 110” may mean that gesture control device 110 is itself entered into a locked state in which gesture control device 110 is unresponsive to physical gestures performed by the user. The unlocked state of interface 100 “with respect to gesture control device 110” may then be achieved by “unlocking” gesture control device 110 with respect to detecting, processing, and/or transmitting control signals in response to, physical gestures performed by the user. In other words, entering interface 100 into an “unlocked state with respect to gesture control device 110” may mean that gesture control device 110 is itself entered into an unlocked state in which gesture control device 110 is responsive to physical gestures performed by the user and transmits control signals to wearable heads-up display 120 in response to physical gestures performed by the user.

In a second example (“Example B”), the locked state of interface 100 “with respect to gesture control device 110” may be achieved by “locking” wearable heads-up display (i.e., the controlled device) with respect to receiving, processing, and/or effecting control signals transmitted by gesture control device 110. In other words, entering interface 100 into a “locked state with respect to gesture control device 110” may mean that gesture control device 110 detects, processes, and/or transmits control signals in response to physical gestures performed by the user in its usual way but wearable heads-up display 120 (i.e., the controlled device) is entered into a locked state in which display content 130 is unresponsive to physical gestures performed by the user. The unlocked state of interface 100 “with respect to gesture control device 110” may then be achieved by “unlocking” wearable heads-up display 120 (i.e., the controlled device) with respect to receiving, processing, and/or effecting control signals transmitted by gesture control device 110. In other words, entering interface 100 into an “unlocked state with respect to gesture control device 110” may mean that wearable heads-up display 120 (i.e., the controlled device) is entered into an unlocked state in which display content 130 is responsive to gestural inputs provided by the user via gesture control device 110.

Further features of gesture control device 110 and wearable heads-up display 120 that enable the exemplary locking/unlocking schemes above (i.e., Example A and Example B) are now described. A person of skill in the art will appreciate, however, that the combination of a gesture control device 110 and a wearable heads-up display 120 that includes an eye-tracker 125 is used only as an exemplary implementation of the present systems, devices, and methods. In practice, the teachings herein may generally be applied using any combination of a first interface device responsive to inputs of a first form from a user and a second interface device responsive to inputs of a second form from the user. To further exemplify this generality, a second example human-electronics interface comprising an eye tracker and a portable interface device having at least one actuator is described later on.

Gesture control device 110 includes a processor 111 and a non-transitory processor-readable storage medium or memory 112 communicatively coupled to processor 111. Memory 112 stores, at least, processor-executable locking instructions 113 and processor-executable unlocking instructions 114. When executed by processor 111, locking instructions 113 cause human-electronics interface 100 to enter into a locked state with respect to gesture control device 110, by, for example, causing gesture control device 110 to enter into a locked state in which device 110 is unresponsive to gestural inputs from the user. When executed by processor 111, unlocking instructions 114 cause human-electronics interface 100 to enter into an unlocked state with respect to gesture control device 110 by, for example, causing gesture control device 110 to enter into an unlocked state in which device 110 is responsive to gestural inputs from the user. Memory 112 may also store processor-executable input processing instructions (not illustrated in FIG. 1) that, when executed by processor 111 while device 110 is in an unlocked state, cause device 110 to, in response to detecting gestural inputs from the user, transmit control signals to a controlled device. To this end, gesture control device 110 also includes a wireless transceiver 115 to send/receive wireless signals (denoted by the two anti-parallel arrows in FIG. 1) to/from wearable heads-up display 120.

Wearables heads-up display 120 also includes a processor 121 and a non-transitory processor-readable storage medium or memory 122 communicatively coupled to processor 121. Processor 121 controls many functions of wearable heads-up display 120, but of particular relevance to the present systems, devices, and methods is that processor 121 is communicatively coupled to eye-tracker 125 (i.e., the second interface device in interface 100) and controls functions and operations thereof. Memory 122 stores, at least, processor-executable input processing instructions 123 that, when executed by processor 121, cause eye-tracker 125 to in response to detecting an eye position and/or gaze direction of the user cause interface 100 to enter into an unlocked state with respect to gesture control device 110. In the exemplary implementation depicted in FIG. 1, instructions 123 may, upon execution by processor 121, cause wearable heads-up display 120 to transmit a signal to gesture control device 110 that, when received by transceiver 115 and processed by processor 111, causes processor 111 to execute unlocking instructions 114. To this end, wearable heads-up display 120 also includes a wireless transceiver 124 to send/receive wireless signals (denoted by the two anti-parallel arrows in FIG. 1) to/from gesture control device 110.

The exemplary implementation described above most closely matches the operational implementation of Example A. However, in accordance with the present systems, devices, and methods a human-electronics interface such as interface 100 may also operate as described in Example B. In this case, processor-executable locking and unlocking instructions (i.e., instructions 113 and 114 in FIG. 1) may be stored in memory 122 on-board wearable heads-up display 120 (i.e., a “controlled device”) rather than (or in addition to) being stored in memory 112 on-board gesture control device 110. In Example B, device 110 may operate in the same way regardless of the locked/unlocked state of interface 100 and wearable heads-up display 120 may be regarded as a “controlled device” (i.e., a responsive device having one or more function(s) and/or operation(s) that is/are controllable by the human using the first interface device as part of the human-electronics interface) with respect to gesture control device 120. When processor 121 executes locking instructions 113, “controlled device” 120 enters into a locked state with respect to gesture control device 110. In the locked state, controlled device 120 (or least, display content 130 provided thereby) is unresponsive to signals received at transceiver 124 from gesture control device 110 and thus gestural control of display content 130 is disabled. Similarly, when processor 121 executes unlocking instructions 114, controlled device 120 enters into an unlocked state with respect to gesture control device 110. In the unlocked state, controlled device 120 (or at least, display content 130 provided thereby) is responsive to signals received at transceiver 124 from gesture control device 110 and thus gestural control of display content 130 is enabled.

In some implementations, human-electronics interface 100 may be operative to return to (e.g., reenter into) the locked state with respect to first interface device 110 based on satisfying one or more criteria. For example, processor-executable locking instructions 113, when executed by first processor 112, further cause human-electronics interface 100 to reenter into the locked state with respect to first interface device 110 in response to at least one trigger. Examples of appropriate triggers include, without limitation: a particular input of the second form detected by second interface device 125, a particular input of the first form detected by first interface device 110, a particular combination of at least one input of the first form detected by first interface device 110 and at least one input of the second form detected by second interface device 125, an elapsed time without detecting any inputs of the first form by first interface device 110, and/or an elapsed time without detecting any inputs of the second form by second interface device 125.

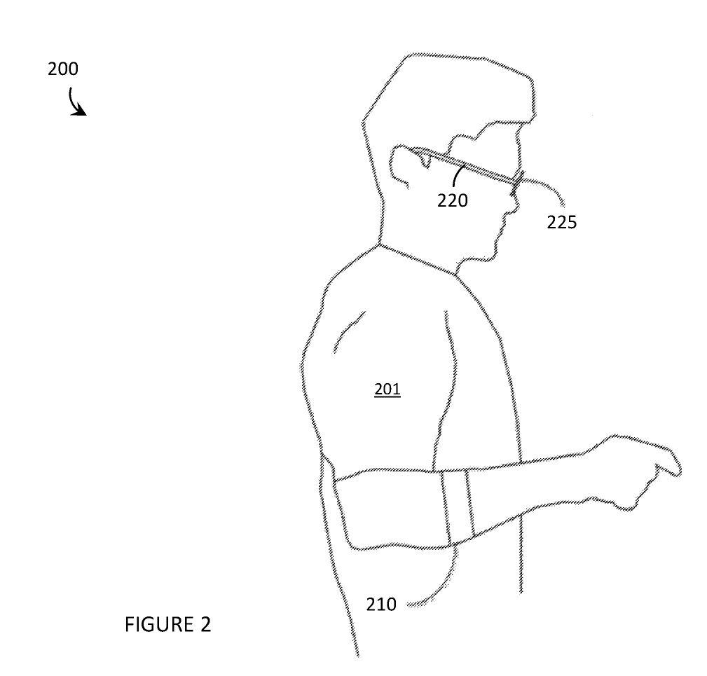

Throughout this specification and the appended claims, the term “user” is generally used to refer to the human component of a human-electronics interface. As the present systems, devices, and methods generally teach human-electronics interfaces that include two interface devices (i.e., a first interface device and a second interface device), a “user” is generally a person who controls, operates, wears (if the device(s) is/are wearable) or generally uses both the first interface device and the second interface device. An exemplary depiction of a user is shown in FIG. 2.

FIG. 2 is an illustrative diagram showing a human-electronics interface 200 in which a user 201 wears both a first interface device 210 and a second interface device 225 in accordance with the present systems, devices, and methods. Interface 200 is substantially similar to interface 100 from FIG. 1 in that first interface device 210 comprises a gesture control device and second interface device 225 comprises an eye-tracker carried on-board a wearable heads-up display 220, where wearable heads-up display 220 is a controlled device as previously described.

The various embodiments described herein mitigate false-positives in human-electronics interfaces by using a first interface device to control the interface and a second interface device to control at least (e.g., sometimes in addition to controlling other aspects of the interface) the locked/unlocked state of the first interface device. Advantageously, the first interface device and the second interface device are respectively responsive to inputs of different forms from the user; that is, the first interface device is responsive to inputs of a first form from the user and the second interface device is responsive to inputs of a second form from the user. In this way, inputs of the first form from the user cannot effect control of the interface without first being “unlocked” by a specific input of the second form from the user. By distinguishing the form of the input that unlocks control of the interface (i.e., inputs of the second form) from the form of the input that actually controls the interface (i.e., inputs of the first form), unwanted “false-positives” of the interface controls are mitigated. This approach may be a particularly advantageous when the first interface device (i.e., the device that actually effects controls of the interface) is an always-on interface device. An always-on interface device is highly susceptible to false positives. If an always-on interface device controls its own locked/unlocked state as is done in conventional human-electronics interfaces, then the always-on interface device is highly susceptible to accidentally unlocking itself through a false positive of the unlocking input and thus the entire interface remains susceptible to false positives due to the always-on interface device becoming accidentally unlocked. The present systems, devices, and methods provide an improved approach to mitigating false positives in always-on interfaces by using a second interface device to control the locked/unlocked state of an always-on interface device, where the second interface device is responsive to inputs from the user of a different form than inputs to which the always-on interface device is responsive.

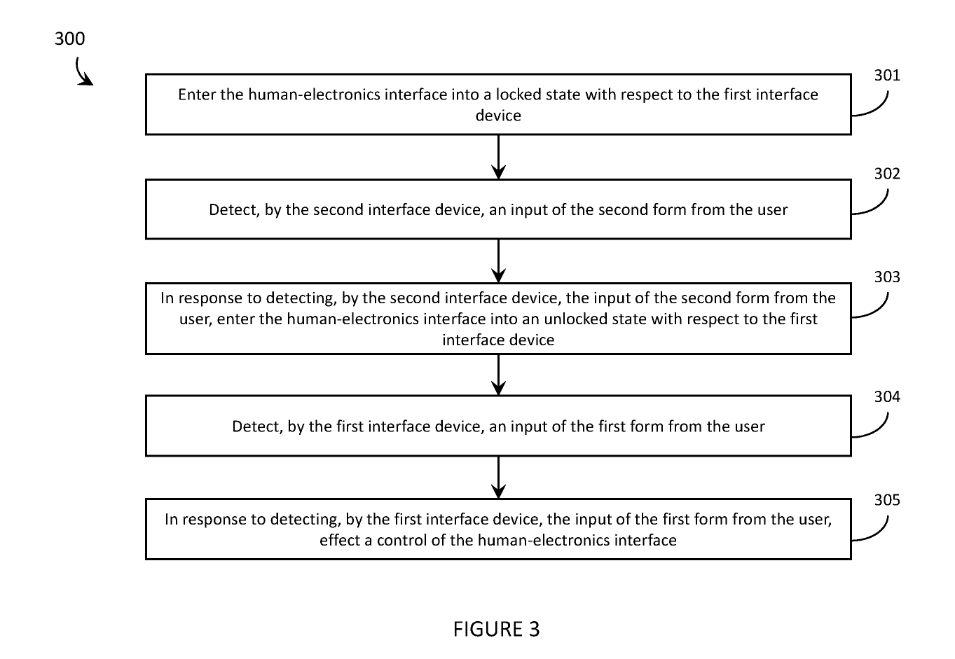

FIG. 3 is a flow-diagram showing an exemplary method 300 of controlling a human-electronics interface in accordance with the present systems, devices, and methods. The human-electronics interface comprises a first interface device responsive to inputs of a first form from the user and a second interface device responsive to inputs of a second form from the user. Method 300 includes five acts 301, 302, 303, 304, and 305, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 301, the human-electronics interface enters into a locked state with respect to the first interface device. As described previously, the human-electronics interface may be entered into a locked state with respect to the first interface device in at least two different ways (i.e., Example A and Example B). In accordance with Example A, entering the human-electronics interface into a locked state with respect to the first interface may include entering the first interface device into a locked state in which the first interface device is unresponsive to inputs of the first form from the user. In this case, the first interface device may include a processor and a non-transitory processor-readable storage medium communicatively coupled to the processor, where the non-transitory processor-readable storage medium stores processor-executable locking instructions that, when executed by the processor, cause the first interface device to enter into the locked state. Alternatively, in accordance with Example B, the human-electronics interface may include a controlled device (e.g., wearable heads-up display 120 from FIG. 1) that is communicatively coupled to the first interface device, and entering the human-electronics interface into a locked state with respect to the first interface device may include entering the controlled device into a locked state in which the controlled device is unresponsive to control signals from the first interface device. In this case, the controlled device may include a processor and a non-transitory processor-readable storage medium communicatively coupled to the processor, where the non-transitory processor-readable storage medium stores processor-executable locking instructions that, when executed by the processor, cause the controlled device to enter into the locked state.

At 302, the second interface device detects a particular input of the second form from the user. The detected input may correspond to an indication from the user that the user wishes to cause the human-electronics interface to enter into an unlocked state with respect to the first interface device. The second interface device may include a processor and a non-transitory processor-readable storage medium communicatively coupled to the processor, where the non-transitory processor-readable storage medium stores processor-executable input processing instructions. In this case, detecting, by the second interface device, a particular input of the second form from the user at 302 may include executing, by the processor, the processor-executable input processing instructions to cause the second interface device to process the particular input of the second form from the user. As described in the exemplary implementation of FIG. 1, the second interface device may include an eye-tracker and inputs of the second form may include specific eye-positions and/or gaze directions of the user. In this case, detecting, by the second interface device, an input of the second form from the user at 302 may include detecting, by the eye-tracker, a particular eye position and/or gaze direction of the user. The eye-tracker may be carried by a wearable heads-up display and the particular eye-position and/or gaze direction of the user may correspond to a specific display region of the wearable heads-up display. For example, the eye-tracker may detect, at 302, when the user is actually looking at content (e.g., specific content) displayed on the wearable heads-up display (such as, for example, a notification or other display content) and then method 300 may proceed to act 303.

At 303, the human-electronics interface enters into an unlocked state with respect to the first interface device in response to a detection of the particular input of the second form by the second interface device at 302. In accordance with Example A, entering the human-electronics interface into an unlocked state with respect to the first interface device may include entering the first interface device into an unlocked state in which the first interface device is responsive to inputs of the first form from the user. Such may include executing, by a processor on-board the first interface device, processor-executable unlocking instructions stored in a memory on-board the first interface device. Alternatively, in accordance with Example B, entering the human-electronics interface into an unlocked state with respect to the first interface device may include entering a “controlled device” into an unlocked state in which the controlled device is responsive to control signals from the first interface device. Such may include executing, by a processor on-board the controlled device, processor-executable unlocking instructions stored in a memory on-board the controlled device.

At 304, the first interface detects an input of the first form from the user. If the first interface device is a gesture control device as in the example of FIG. 1, then the first interface device may detect a physical gesture performed by the user at 304.

At 305, a control of the human-electronics interface is effected in response to detection of the input of the first form by the first interface device at 304. Act 305 is, in accordance with the present systems, devices, and methods, only executable as a result of the human-electronics interface being unlocked with respect to the first interface device, by the second interface device, at acts 302 and 303. FIG. 1 provides an exemplary implementation in which control of the human-electronics interface is effected in the form of interactions with content displayed on a wearable heads-up display; however, in alternative implementations control of the human-electronics interface may take on a very wide variety of other forms. Some implementations may employ alternative interface devices other than an eye-tracker and/or a gesture control device, such as, without limitation: voice control, motion capture, tactile control through a track pad and/or one or more button(s), body-heat detection, electroencephalographic control, input detection through electrocardiography, and so on. Similarly, alternative implementations may not involve display content and effecting control of a human-electronics interface may be realized in other ways, such as without limitation: control of sounds and/or music, control of a vehicular or robotic device, control of an environmental parameter such as temperature or light, control of an appliance or software application, and so on.

In FIG. 1, eye-tracker 125 is carried by a wearable heads-up display 120 and control of human-electronics interface 100 manifests itself in the form of interactions with display content 130. In an alternative implementation, wearable heads-up display 120 may include a forward-facing camera (not illustrated) and control of human-electronics interface 100 may involve identifying when the user is looking at a particular controlled device (e.g., on its own, or among multiple potential controlled devices) and, in response to identifying that the user is looking at the particular controlled device, unlocking the particular controlled device with respect to the first interface device. For example a controlled device (or multiple controlled devices) may be initially paired with the first interface device and then entered into a locked state with respect to the first interface device. A forward-facing camera on a wearable heads-up display (or more generally, on a pair of smartglasses that include a forward-facing camera and may or may not be operative to display virtual content to the user) may identify the controlled device (or multiple candidate controlled devices) in the user's field of view. An eye-tracker on the pair of smartglasses may identify when the user is looking at the controlled device (or a select one of multiple candidate controlled devices) and, in response to the user looking at the controlled device (e.g., for a defined period of time, such as 2 seconds), the eye-tracker may send a signal (e.g., through a transceiver on-board the smartglasses) to the controlled device (e.g., the particular controlled device among multiple candidate controlled devices) that, when received by the controlled device, causes the controlled device to enter into an unlocked state with respect to the first interface device. In this way, the present systems, devices, and methods may be advantageously adopted in implementations where selective control of one or more controlled device(s) via a first interface device is desired, the control being effected by a second interface device that governs the locked/unlocked state of the first interface device with respect to the controlled device.

Method 300 may include additional acts. For example, method 300 may further include reentering the human-electronics interface into the locked state with respect to the first interface device based on any of a wide variety of conditions and/or in response to a wide variety of different triggers, such as without limitation: after a prescribed amount of time has elapsed (e.g., one second after entering the unlocked state, two seconds after entering the unlocked state, five second after entering the unlocked state, and so on), after the interface responds to a prescribed number of inputs of the first form from the user via the first interface device (e.g., after the interface responds to one input of the first form, after the interface responds to two inputs of the first form, and so on), based on a particular input of the first form detected by the first interface device, based on a particular input of the second form detected by the second interface device, based on a particular combination of at least one input of the first form detected by the first interface device and at least one input of the second form detected by the second interface device, based on an elapsed time without detecting any inputs of the first form by the first interface device, and/or based on an elapsed time without detecting any inputs of the second form by the second interface device. If the second interface device comprises an eye-tracker and act 302 comprises detecting, by the eye-tracker, a particular eye position and/or gaze direction of the user, then the interface may be reentered into the locked state with respect to the first interface device in response to detecting, by the eye-tracker, that the eye position and/or gaze direction of the user has changed from the particular eye position and/or gaze direction that previously caused the interface to enter into the unlocked state with respect to the first interface device at 302 and 303.

As previously described, a human-electronics interface that employs a gesture control device 110 as the first interface device and an eye tracker 125 on-board a wearable heads-up display 120 as the second interface device (as depicted in FIG. 1) is used herein as an exemplary implementation only. Alternative implementations may employ an alternative (e.g., non-gesture-based) interface device as the first interface device and/or an alternative (e.g., a non-eye-tracking-based) interface device as the second interface device and alternative implementations may or may not employ a wearable heads-up display. As an example of an implementation of the present systems, devices, and methods that does not employ a gesture-based first interface device, the first interface device may instead be a portable interface device that includes at least one actuator where inputs of the first form correspond to activations of the at least one actuator by the user.

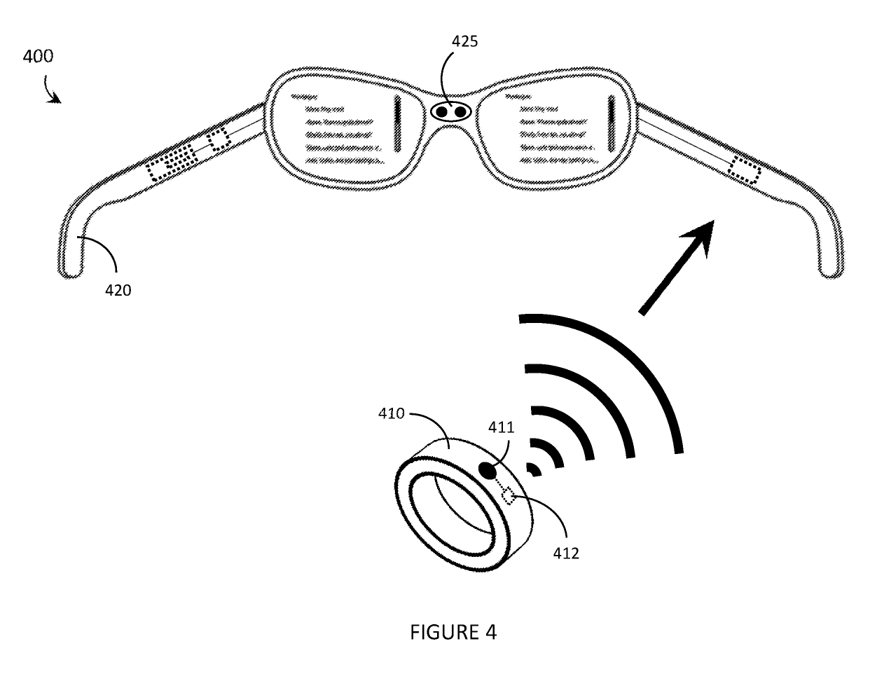

FIG. 4 is an illustrative diagram of an exemplary human-electronics interface 400 comprising a first interface device 410 that is responsive to inputs of a first form from a user and a second interface device 425 that is responsive to inputs of a second form from the user in accordance with the present systems, devices, and methods. In exemplary interface 400, first interface device 110 is a portable interface device in the form of a ring that in use is worn on a finger or thumb of the user. Ring 410 includes at least one actuator 411 (e.g., a button, switch, toggle, lever, or other manually-actuatable component) and inputs of the first form correspond to activations of at least one actuator 411 by the user. Actuator 411 is communicatively coupled to a wireless signal transmitter 412 that transmits one or more wireless signal(s) (e.g., electromagnetic signals, radio frequency signals, optical signals, and/or acoustic signals such as ultrasonic signals) in response to activations of at least one actuator 411. An example of a portable interface device that may be used as ring 410 is described in U.S. Provisional Patent Application Ser. No. 62/236,060.

Human-electronics interface 400 is similar to human-electronics interface 100 from FIG. 1 in that human-electronics interface device 400 also includes a wearable heads-up display 420 (as a controlled device) that carries an eye tracker 425. Eye tracker 425 serves the role of the second interface device in human-electronics interface 400; thus, apart from the replacement of gesture control device 110 by portable interface device (or ring) 420, human-electronics interface 400 may be substantially similar to human-electronics interface 100.

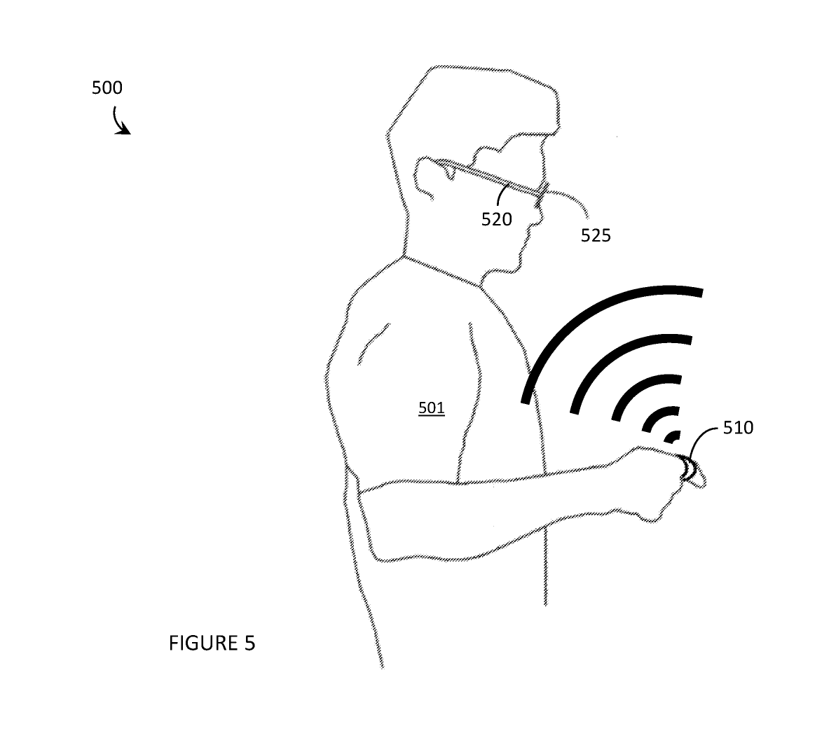

FIG. 5 is an illustrative diagram showing a human-electronics interface 500 in which a user 501 wears both a first interface device 510 and a second interface device 525 in accordance with the present systems, devices, and methods. Interface 500 is substantially similar to interface 400 from FIG. 4 in that first interface device 510 comprises a portable interface device (e.g., a ring) having at least one actuator and second interface device 525 comprises an eye-tracker carried on-board a wearable heads-up display 520, where wearable heads-up display 520 is a controlled device as previously described.

In the various implementations described herein (e.g., as depicted in FIGS. 1, 2, 3, 4, and 5) the nature and/or role of the first interface device and the second interface device may be reversed or swapped if desired. That is, while the descriptions of FIGS. 1 and 2 cast the gesture control device 110/210 as the first interface device and the eye tracker 125/225 as the second interface device, in alternative implementations the eye tracker 125/225 may function as the first interface device and the gesture control device 110/210 may function as the second interface device. Similarly, while the descriptions of FIGS. 4 and 5 cast the portable interface device (e.g., ring) 410/510 as the first interface device and the eye tracker 425/525 as the second interface device, in alternative implementations the eye tracker 425/525 may function as the first interface device and the portable interface device (e.g., ring) 410/510 may function as the second interface device.

The present systems, devices, and methods may be combined with the teachings of other US patent filings relating to interface devices, in particular gesture control devices and wearable heads-up displays. For example, the present systems, devices, and methods may be combined with the teachings of any or all of: U.S. Provisional Patent Application Ser. No. 61/989,848 (now US Patent Publication US 2015-0325202 A1); U.S. Non-Provisional patent application Ser. No. 14/658,552 (now US Patent Publication US 2015-0261306 A1); US Patent Publication US 2015-0057770 A1; and/or U.S. Provisional Patent Application Ser. No. 62/134,347 (now U.S. Non-Provisional patent application Ser. No. 15/070,887); each of which is incorporated by reference herein in its entirety.

The various eye trackers described herein may employ any of a variety of different eye tracking technologies depending on the specific implementation, including without limitation any or all of the systems, devices, and methods described in U.S. Provisional Patent Application Ser. No. 62/167,767; U.S. Provisional Patent Application Ser. No. 62/271,135; U.S. Provisional Patent Application Ser. No. 62/245,792; and/or U.S. Provisional Patent Application Ser. No. 62/281,041.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), one or more communicative link(s) through one or more wireless communication protocol(s), and/or optical pathways (e.g., optical fiber), and exemplary communicative couplings include, but are not limited to, electrical couplings, magnetic couplings, wireless couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to: U.S. Non-Provisional patent application Ser. No. 15/072,918; U.S. Provisional Patent Application Ser. No. 62/136,207, US Patent Publication US 2014-0198035 A1; U.S. Provisional Patent Application Ser. No. 62/236,060; U.S. Provisional Patent Application Ser. No. 61/989,848 (now US Patent Publication US 2015-0325202 A1); U.S. Non-Provisional patent application Ser. No. 14/658,552 (now US Patent Publication US 2015-0261306 A1); US Patent Publication US 2015-0057770 A1; U.S. Provisional Patent Application Ser. No. 62/134,347 (now U.S. Non-Provisional patent application Ser. No. 15/070,887); U.S. Provisional Patent Application Ser. No. 62/167,767; U.S. Provisional Patent Application Ser. No. 62/271,135; U.S. Provisional Patent Application Ser. No. 62/245,792; and/or U.S. Provisional Patent Application Ser. No. 62/281,041, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A human-electronics interface comprising:
a first interface device responsive to inputs of a first form from a user, wherein in response to detecting an input of the first form from the user the first interface device transmits at least one control signal;
a controlled device that includes a first processor and a first non-transitory processor-readable storage medium communicatively coupled to the first processor, wherein the first non-transitory processor-readable storage medium stores:
processor-executable locking instructions that, when executed by the first processor, cause the controlled device to enter into a locked state in which the controlled device is unresponsive to control signals from the first interface device; and
processor-executable unlocking instructions that, when executed by the first processor, cause the controlled device to enter into an unlocked state in which the controlled device is responsive to control signals from the first interface device; and
a second interface device responsive to inputs of a second form from the user, the second form different from the first form, wherein the second interface device includes a second processor and a second non-transitory processor-readable storage medium communicatively coupled to the second processor, and wherein the second non-transitory processor-readable storage medium stores processor-executable input processing instructions that, when executed by the second processor, cause the second interface device to:
in response to detecting an input of the second form from the user, cause the first processor of the controlled device to execute the processor-executable unlocking instructions.

2. The human-electronics interface of claim 1 wherein the controlled device includes a wearable heads-up display that carries the second interface device, and wherein the second interface device includes an eye tracker and inputs of the second form include specific eye-positions and/or gaze directions of the user that correspond to specific display regions of the wearable heads-up display.

3. The human-electronics interface of claim 1 wherein the first interface device includes at least one device selected from a group consisting of: a gesture control device for which inputs of the first form include gestures performed by the user and detected by the gesture control device, and a portable interface device that includes at least one actuator for which inputs of the first form include activations of at least one actuator ice by the user.

4. The human-electronics interface of claim 1 wherein the processor-executable locking instructions that, when executed by the first processor of the controlled device while the controlled device is in the unlocked state with respect to the first interface device, cause the controlled device to enter into a locked state with respect to the first interface device, cause the controlled device to enter into the locked state with respect to the first interface device in response to at least one trigger selected from a group consisting of: a particular input of the second form detected by the second interface device, a particular input of the first form detected by the first interface device, a particular combination of at least one input of the first form detected by the first interface device and at least one input of the second form detected by the second interface device, an elapsed time without detecting any inputs of the first form by the first interface device, and an elapsed time without detecting any inputs of the second form by the second interface device.
